(19) United States
(12) Patent Application Publication
(10) Pub. No.: US 2004/0079914 A1
(43) Pub. Date: Apr. 29, 2004

(54) Purge valve with improved air flow control

(76) Inventors: Santos Burrola, Chihuahua (MX); Manuel A. Quintana, Chihuahua (MX)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/278,619

(22) Filed: Oct. 23, 2002

(51) Int. Cl. F16K 31/02

(52) U.S. Cl. 251/129.15

(57) ABSTRACT

Valve (and method for arranging the valve) are provided for a purge control system in an internal combustion engine. The valve includes an inlet port operable at a first pressure level. The valve further includes an outlet port operable at a second pressure level different than the first pressure level. A plunger may be positioned in a chamber for selectively communicating the inlet port with respect to the outlet port. The plunger may be configured to move into a closed position wherein the plunger prevents communication between the inlet and outlet ports. The plunger includes a passageway for communicating the outlet port with the chamber so as to equalize relative pressure between the outlet port and the chamber and avoid pressure-induced forces in the closed position. The plunger is further configured to move into an open position in response to an actuating signal wherein the plunger enables communication between the inlet and the outlet ports. The actuation of the valve from the closed to the open position is in temporal alignment with the actuating signal in view of the avoidance of any pressure-induced force on the plunger.

### BACKGROUND OF THE INVENTION

Environmental regulations for automotive-related emissions have been evolving over the years to more rigorously prescribe the levels of emissions that may be discharged into the atmosphere, such as fuel vapors that may accumulate in the fuel tank of an automobile. Accordingly, evaporative systems for reducing the discharge of these vapors into the atmosphere have to accurately meet such regulations. At the same time, the evaporative systems should be reliably and affordably constructed to enable suppliers in the automotive industry to successfully compete in the marketplace.

Known purge control actuators have yet to consistently address various environmental and operational variables in order to provide appropriate calibration to fuel or air delivery devices (or both) in internal combustion engines that, for example, may purge fuel vapors at idle speeds. In particular, precise control of the opening point of a purge valve is one important factor to provide an accurate mixture of fuel and air to such engines. Unfortunately, known purge control actuators are generally subject to undesirable variation in the opening point of the purge valve due to changes that may occur in engine intake manifold pressure (e.g., vacuum).

FIG. 1 plots respective waveforms indicative of air flow as a function of the duty cycle at which the valve may be operated for two exemplary manifold pressures in one prior art purge actuator. FIG. 2 provides a zoomed-in view of FIG. 1 illustrating an exemplary lag (represented by arrow 3) for the opening of the control valve. FIG. 2 further illustrates undesirable turbulence in the waveform indicative of air flow that may degrade operation of the engine during an idling condition and result in incrementally higher emissions into the atmosphere.

In view of the foregoing considerations, it would be desirable to provide a purge valve that has a consistent opening point regardless of variation of engine intake manifold pressure. It would be further desirable to provide a purge valve that results in a smoother air flow so as to enable improved control of the air-fuel mixture supplied to the engine and thus reduce the level of emissions from the engine.

### BRIEF SUMMARY OF THE INVENTION

Generally, the present invention fulfills the foregoing needs by providing in one aspect thereof, a valve for a purge control system in an internal combustion engine. The valve includes an inlet port operable at a first pressure level. The valve further includes an outlet port operable at a second pressure level different than the first pressure level. A plunger may be positioned in a chamber for selectively communicating the inlet port with respect to the outlet port. The plunger may be configured to move into a closed position wherein the plunger prevents communication between the inlet and outlet ports. The plunger includes a passageway for communicating the outlet port with the chamber so as to equalize relative pressure between the outlet port and the chamber and avoid pressure-induced forces in the closed position. The plunger is further configured to move into an open position in response to an actuating signal wherein the plunger enables communication between the inlet and the outlet ports.

In another aspect thereof, the present invention further fulfills the foregoing needs by providing a method for arranging a valve in a purge control system in an internal combustion engine. The method allows providing an inlet port operable at a first pressure level and an outlet port operable at a second pressure level different than the first pressure level. The method further allows positioning a plunger in a chamber for selectively communicating the inlet port with respect to the outlet port. The plunger may be configured to slide into a closed position wherein the plunger prevents communication between the inlet and outlet ports. A passageway is provided in the plunger for communicating the outlet port with the chamber to equalize relative pressure between the outlet port and the chamber and avoid pressure-induced forces in the closed position. The plunger may be further configured to retract into an open position in response to an actuating signal wherein the plunger enables communication between the inlet and the outlet ports.

### BRIEF DESCRIPTION OF THE DRAWINGS

The features and advantages of the present invention will become apparent from the following detailed description of the invention when read with the accompanying drawings in which:

FIG. 1 illustrates respective waveforms indicative of air flow as a function of the duty cycle at which a purge valve may be operated for two exemplary manifold pressures in one prior art purge actuator.

FIG. 2 provides a zoomed-in view of FIG. 1 illustrating operational drawbacks regarding air flow in one prior art purge valve.

FIG. 3 is a cross-sectional view of an exemplary prior art purge valve including a plunger subject to undesirable vacuum-induced forces.

FIG. 4 illustrates an exemplary free body diagram of forces acting on the valve of FIG. 3.

FIG. 5 is a cross-sectional view of a purge valve embodying aspects of the present invention.

FIG. 6 illustrates an exemplary free body diagram of forces acting on the valve of FIG. 5.

FIG. 7 illustrates exemplary structural details of a purge valve embodying aspect of the present invention.

FIG. 8 illustrates the three regular views of an exemplary plunger insert, such as may be used in the valve of FIG. 7.

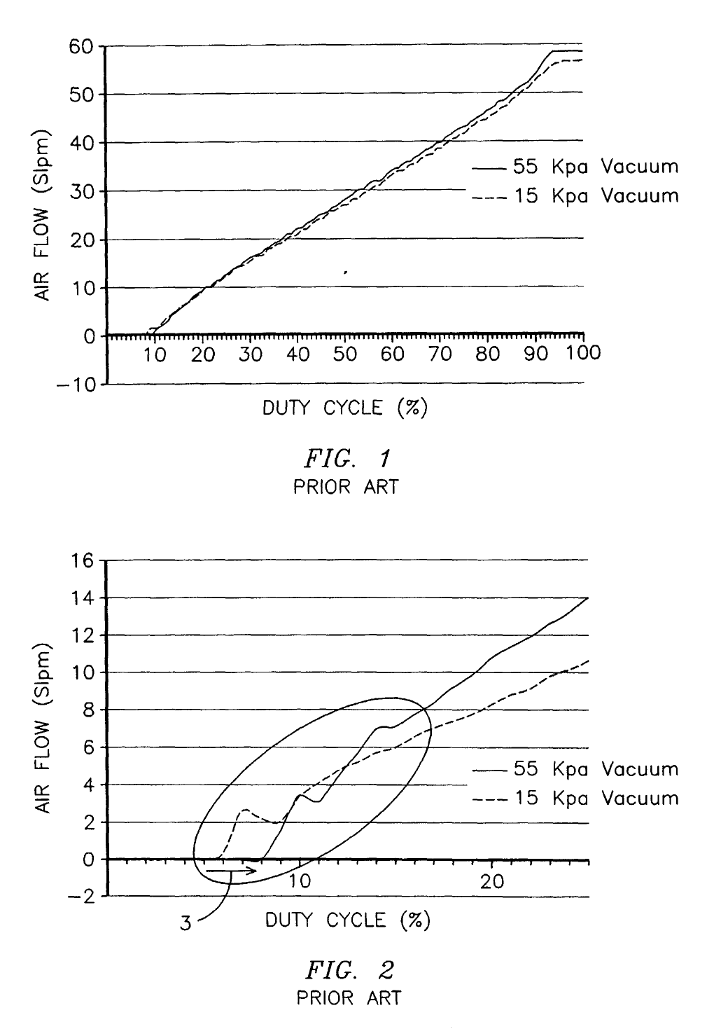

### DETAILED DESCRIPTION OF THE INVENTION

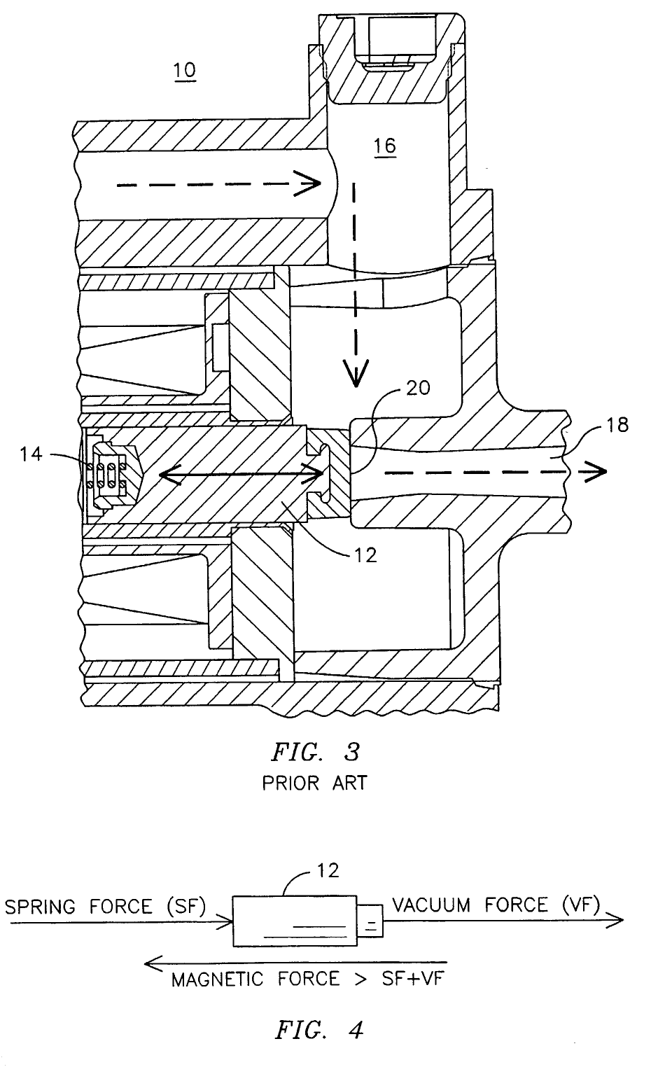

FIG. 3 is a cross-sectional view of an exemplary prior art purge valve 10 that is shown to appreciate some of the problems, which are now advantageously solved by aspects of the present invention. As shown in FIG. 3, valve 10 includes a normally closed plunger 12 that may slide to an open condition in response to an appropriate voltage signal connected to an associated electromagnetic plunger actuator (not shown). Plunger 12 may be spring-biased by a suitable spring 14 to be in a normally-closed position. Purge valve 10, in response to the voltage signal applied to the associated actuator, allows to selectively communicate an inlet port 16 with an outlet port 18 through an opening 20. Inlet port 16 in operation may be at atmospheric pressure while outlet port 18 may be at the engine intake manifold pressure (e.g., vacuum). That is, at a pressure less than atmospheric pressure. Consequently, when the purge valve is closed, the vacuum in the outlet port produces an axial force in the plunger tip area. That is, the tip area that normally plugs opening 20. It will be appreciated that the level of the axial force that develops on the plunger will vary depending on the magnitude of the vacuum. As suggested above, the opening point of the valve may be undesirable influenced by vacuum variation in the outlet port since the lower the magnitude of the vacuum, the more force that acts on the plunger, which may result in a lag (e.g., time delay) prior to overcoming the vacuum-induced force, and which may further result in air flow turbulence as the valve transitions to an open condition.

FIG. 4 illustrates an exemplary free body diagram of forces acting on the plunger of FIG. 3. As illustrated in FIG. 4, in order to set the purge valve to an open condition, the force supplied by the actuator needs to overcome both the spring force as well as the vacuum force that develops at the tip of the plunger.

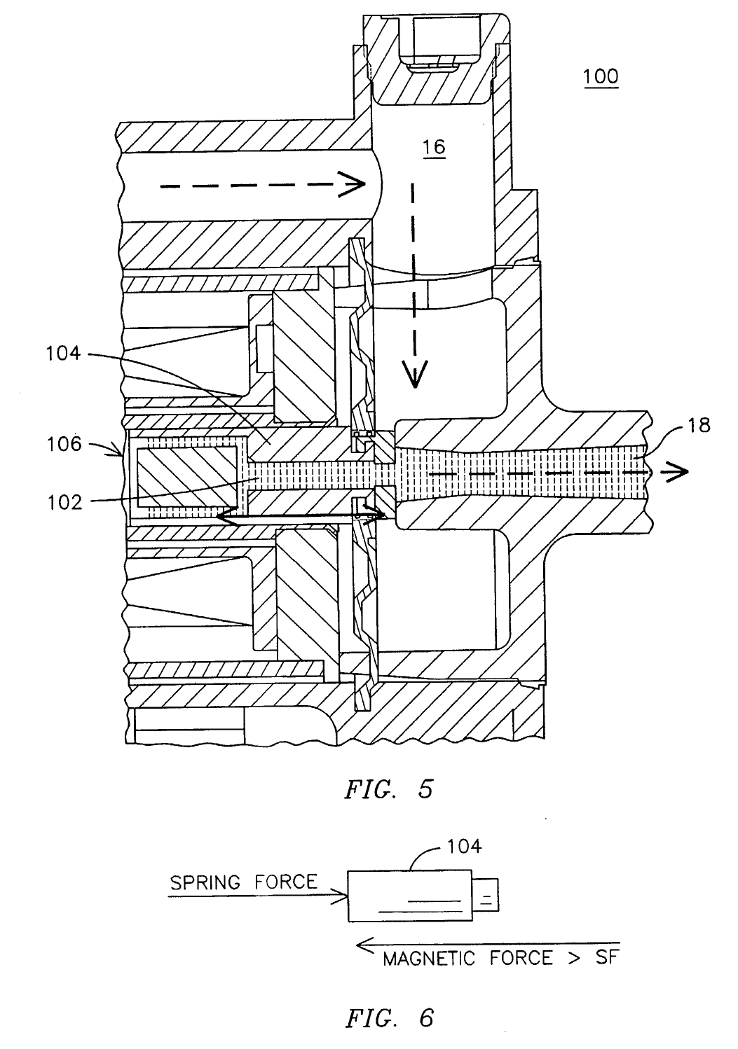

FIG. 5 is a cross-sectional view of a purge valve 100 embodying aspects of the present invention. The inventors of the present invention have innovatively recognized that providing a passageway or conduit 102 (e.g., an axially-extending passageway) in plunger 104 would allow equalizing the relative pressure between outlet port 18 and a chamber 106 where the plunger is disposed. That is, outlet port 18 would be in communication through opening 20 with passageway 102 and with chamber 106 but would not be in communication with the inlet port during the closed condition of the valve (e.g., not purging condition). Thus, as illustrated in FIG. 6, in the exemplary free body diagram of forces acting on the plunger of FIG. 5, it will be appreciated that when the valve is closed, outlet port 18, passageway 102 and chamber 106 each would have the same pressure relative to one another. Thus, in a purge valve embodying aspects of the present invention, e.g., purge valve 100, there is no vacuum-induced force applied to the plunger tip area in the closed condition, and consequently the opening point of the valve would not be subject to any lags or turbulence that otherwise could develop when the valve transitions from the closed to the open condition. That is, the valve may be actuated from the closed to open position in substantial temporal alignment with the actuating signal.

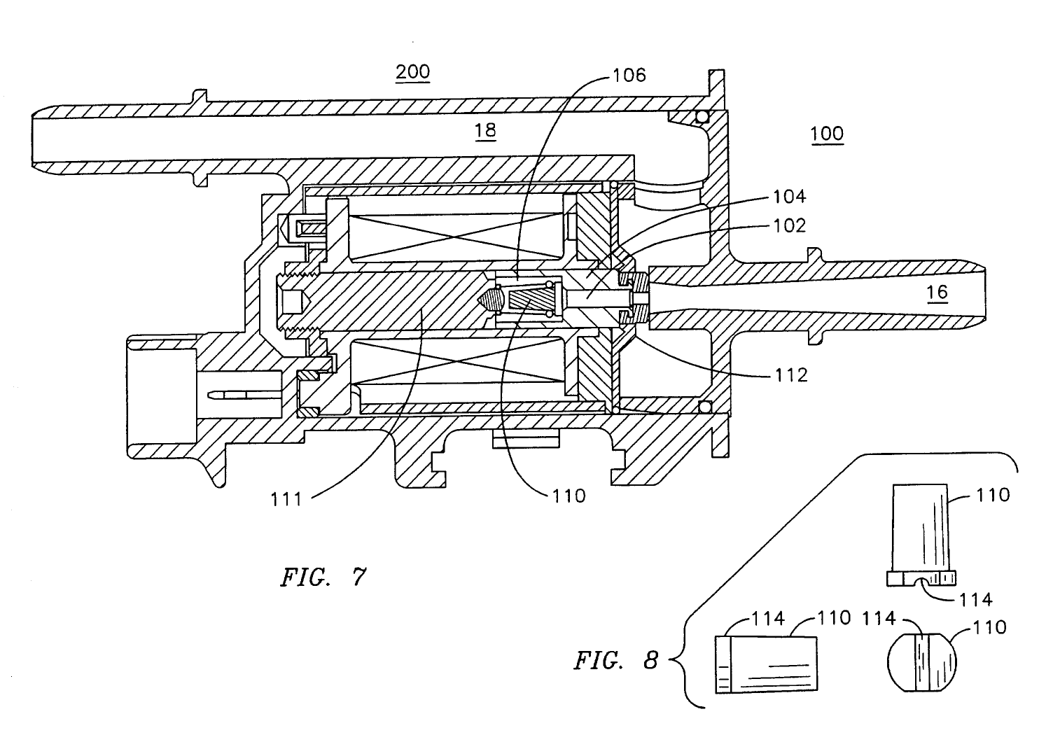

FIG. 7 illustrates one exemplary embodiment of a purge valve 200 embodying aspects of the present invention. As shown in FIG. 7, a plunger insert 110 is operatively connected to plunger 104. Plunger insert 110 may be made of plastic or any other suitable polymer and may configured to provide support against a stop 112 when the plunger is fully retracted. As best appreciated in the three regular views of plunger insert 110 in FIG. 8, a radially-extending groove 114 may be provided in plunger insert 110 to provide communication between passageway 102 and the chamber 106 where the plunger is disposed. As further illustrated in FIG. 7, a pressure-isolation diaphragm 112, such as may be made of rubber or any suitable elastomer, may be provided to form a seal between inlet port 16 (e.g., at atmospheric pressure) and outlet port 18 and passageway 102 (e.g., at a vacuum when the valve is closed). Thus, the pressure-isolation diaphragm allows isolating during the closed condition of the valve the regions with equalized pressure (e.g., vacuum) from atmospheric pressure.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A valve for a purge control system in an internal combustion engine, the valve comprising:
an inlet port operable at a first pressure level;
an outlet port operable at a second pressure level different than the first pressure level;
a plunger positioned in a chamber for selectively communicating the inlet port with respect to the outlet port, the plunger configured to move into a closed position wherein the plunger prevents communication between the inlet and outlet ports, the plunger including a passageway for communicating the outlet port with the chamber to equalize relative pressure between the outlet port and the chamber and avoid pressure-induced forces in the closed position, the plunger further configured to move in response to an actuating signal into an open position wherein the plunger enables communication between the inlet and the outlet ports.

2. The valve of claim 1 wherein the passageway extends axially through the plunger.

3. The valve of claim 2 further comprising a plunger insert connected at the back end of the plunger, the plunger insert including a radially-extending groove to provide communication between the passageway and the chamber.

4. The valve of claim 1 further comprising a diaphragm configured to form a seal about the inlet port with respect to the outlet port and the passageway when the valve is closed.

5. The valve of claim 4 wherein the diaphragm is mounted on the front end of the plunger.

6. A method for arranging a valve in a purge control system in an internal combustion engine, the method comprising:
providing an inlet port operable at a first pressure level;
providing an outlet port operable at a second pressure level different than the first pressure level;
positioning a plunger in a chamber for selectively communicating the inlet port with respect to the outlet port;
configuring the plunger to slide into a closed position wherein the plunger prevents communication between the inlet and outlet ports;
providing a passageway in the plunger for communicating the outlet port with the chamber to equalize relative pressure between the outlet port and the chamber and avoid pressure-induced forces in the closed position; and
configuring the plunger to retract into an open position in response to an actuating signal wherein the plunger enables communication between the inlet and the outlet ports.

7. The method of claim 6 wherein the passageway extends axially through the plunger.

8. The method of claim 7 further comprising connecting a plunger insert at the back end of the plunger, the plunger insert including a radially-extending groove to provide communication between the passageway and the chamber.

9. The method of claim 6 further comprising configuring a diaphragm to form a seal about the inlet port with respect to the outlet port and the passageway when the valve is closed.

10. The method of claim 9 wherein the diaphragm is mounted on the front end of the plunger.

11. The method of claim 6 further comprising actuating the valve from the closed to the open position in substantial temporal alignment with the actuating signal.
